(19) United States
(12) Patent Application Publication
(10) Pub. No.: US 2020/0281234 A1
(43) Pub. Date: Sep. 10, 2020

(54) HIGH-FREQUENCY THAWING APPARATUS

(71) Applicant: SHARP KABUSHIKI KAISHA, Sakai City (JP)

(72) Inventor: TAKUSHI KISHIMOTO, Sakai City (JP)

(21) Appl. No.: 16/807,885

(22) Filed: Mar. 3, 2020

(30) Foreign Application Priority Data
Mar. 7, 2019 (JP) 2019-041856

(51) Int. Cl. A23L 3/365; A23L 5/30; A23L 3/36

(52) U.S. Cl. CPC A23L 3/365; A23V 2002/00; A23L 3/363; A23L 5/30

(57) ABSTRACT

Provided is a high-frequency thawing apparatus that requires no setting of a thawing time and provides high precision in thawing finishing. The high-frequency thawing apparatus includes the following: a heating chamber; upper and lower electrodes with a to-be thawed object interposed therebetween, the upper and lower electrodes being disposed in parallel to each other in the heating chamber a high-frequency power source and matching circuit that applies a high-frequency voltage between the upper and lower electrodes; a power detecting circuit that detects the reflective power of the applied high-frequency voltage; and a controller that determines thawing completion, by estimating the progress status of the to-be thawed object on the basis of how a detected signal detected by the power detecting circuit has changed since thawing was started, the controller controlling the high-frequency power source on the basis of a determination.

### BACKGROUND OF THE INVENTION

### Field of the Invention

The present invention relates to a high-frequency thawing apparatus that thaws a to-be thawed object (e.g., frozen food) by applying a high-frequency electric field to the to-be thawed object.

### Description of the Background Art

A high-frequency thawing apparatus is known that thaws a to-be thawed object, such as a frozen food, through dielectric heating by applying a high-frequency electric field of the order of a megahertz or higher (c.f., Japanese Patent Application Laid-Open No. 2004-57101 and Japanese Patent Application Laid-Open No. 2005-149828).

The high-frequency thawing apparatus includes upper and lower electrodes in its heating chamber, and applies a high-frequency electric field between both electrodes from its high-frequency power source. This causes dielectric loss in the to-be thawed object, thus thawing the to-be thawed object. In a dielectric heating mode, a parallel electric field reaches the inside of a frozen food uniformly. This mode is hence more suitable fir thawing a large to-be thawed object than micro-wave thawing with a microwave oven.

Unfortunately, the conventional high-frequency thawing apparatus sets a predetermined processing time in accordance with the type and quantity (i.e., size and weight) of a to-be thawed object; for 1000 grams of meat for instance, the high-frequency thawing apparatus sets 15 minutes for processing. The high-frequency thawing apparatus, before it starts processing, hence needs to recognize the type and quantity of a to-be thawed object to set a processing time according to the type and quantity.

In addition, a predetermined processing time of thawing causes excessive thawing resulting from too long a processing time or conversely causes insufficient thawing resulting from too short a processing time, depending on the shape of a food or on the initial temperature (i.e., temperature before thawing start) of the food. Hence, the high-frequency thawing apparatus unfortunately fails to achieve stable precision in thawing finishing.

### SUMMARY

It is an object of f one aspect of the present invention to achieve a high-frequency thawing apparatus that requires no setting of a thawing time, and provides high precision in thawing finishing.

To solve the above problem, the high-frequency thawing apparatus according to the aspect of the present invention includes the following: a heating chamber, upper and lower electrodes with a to-be thawed object interposed therebetween, the upper and lower electrodes being disposed in parallel to each other in the heating chamber, a voltage applying unit that applies a high-frequency voltage between the upper and lower electrodes; a reflective-power detecting unit that detects the reflective power of the high-frequency voltage applied by the voltage applying unit; a thawing-completion determining unit that determines thawing completion, by estimating the progress status of the to-be thawed object on the basis of how a detected signal detected by the reflective-power detecting unit has changed since thawing was started; and a control unit that controls the voltage applying unit on the basis of a determination made by the thawing-completion determining unit.

The aspect of the present invention achieves a high-frequency thawing apparatus that requires no setting of a thawing time and provides high precision in thawing finishing.

### BRIEF DESCRIPTION OF THE DRAWINGS

FIG. 1 schematically illustrates the configuration of a high-frequency thawing apparatus according to a first preferred embodiment of the present invention:

FIG. 2 illustrates the configuration of a circuit within the high-frequency thawing apparatus;

FIG. 3 is a graph showing the relationship between thawing progress status, and detected signals of incident power and reflective power that are detected by a power detecting circuit of the high-frequency thawing apparatus while a to-be thawed object is being thawed.

FIG. 4 is a flowchart showing the operation of the high-frequency thawing apparatus;

FIG. 5 is a graph showing the relationship between thawing progress status, and the detected signals of the incident power and reflective power that are detected by the power detecting circuit of the high-frequency thawing apparatus while the to-be thawed object is being thawed, and FIG. 5 is different from FIG. 3 in the initial temperature of the to-be thawed object; and

FIG. 6 is a flowchart showing the operation of a high-frequency thawing apparatus according to a second preferred embodiment of present invention.

### DESCRIPTION OF THE PREFERRED EMBODIMENTS

### First Preferred Embodiment

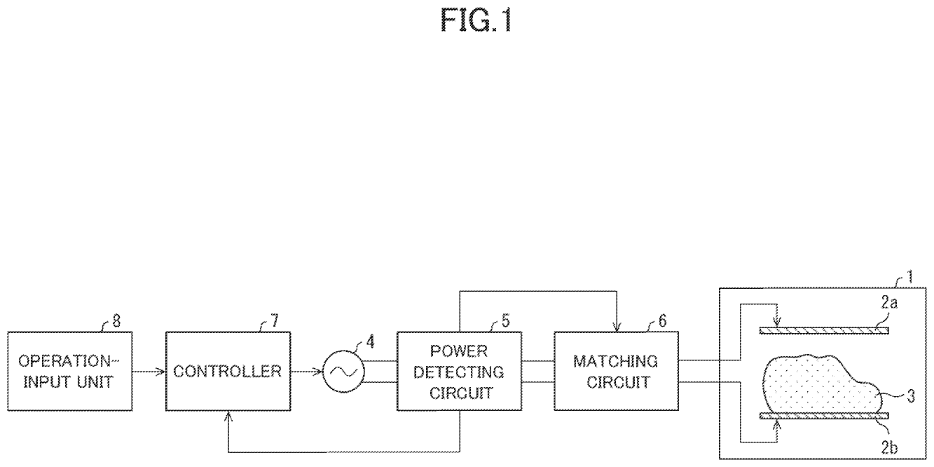

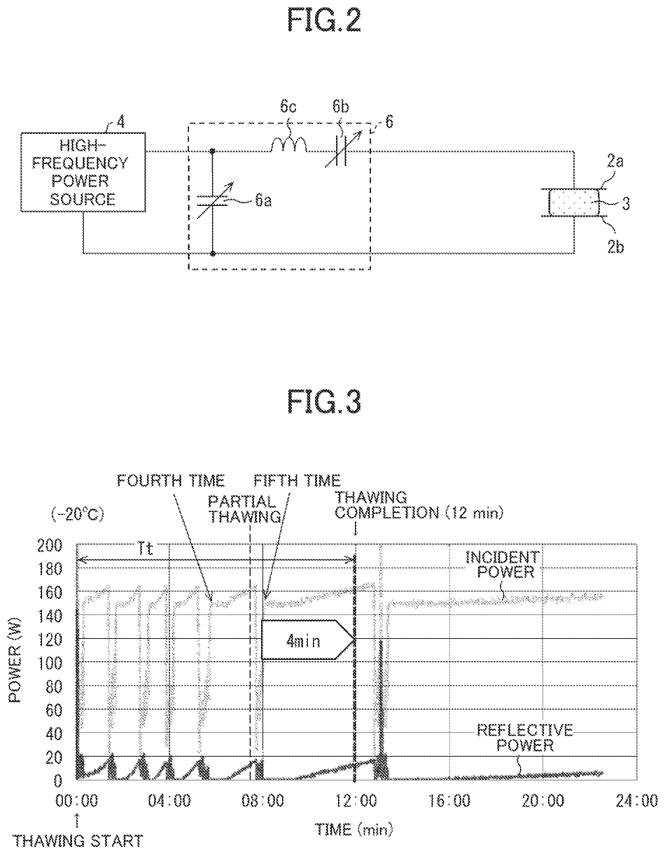

A first preferred embodiment of the present invention will be detailed. With reference to FIGS. 1 and 2, the following describes the schematic configuration of a high-frequency thawing apparatus according to the present preferred embodiment. FIG. 1 schematically illustrates the configuration of the high-frequency thawing apparatus according to the present preferred embodiment. FIG. 2 illustrates the configuration of a circuit within the high-frequency thawing apparatus.

The high-frequency thawing apparatus performs thawing and other processing on a to-be thawed object 3 (e.g., frozen food) by applying a high-frequency electric field to the to-be thawed object 3. More specifically, the high-frequency thawing apparatus is a thawing apparatus in dielectric-heating mode. The thawing apparatus in this mode uses a principle where a dielectric, upon application with a high-frequency electric field, generates heat (i.e., dielectric loss) resulting from molecule friction, thus being heated. With this heat resulting from dielectric loss, the high-frequency thawing apparatus thaws the to-be thawed object 3 placed in a parallel electric field that occurs between the parallel electrodes applied with a high-frequency voltage.

As illustrated in FIG. 1, the high-frequency thawing apparatus includes a heating chamber 1, an upper electrode 2a, a lower electrode 2b, a high-frequency power source 4, a power detecting circuit 5, a matching circuit 6, a controller (i.e., thawing-completion determining unit and control unit) 7, an operation-input unit 8, and other components. The high-frequency power source 4 and matching circuit 6 constitute a voltage applying unit that applies a high-frequency voltage between the upper electrode 2a and lower electrode 2b.

The heating chamber 1 is formed of a metal casing. The upper electrode 2a and lower electrode 2b are disposed in the heating chamber 1 so as to be vertically parallel to each other. The to-be thawed object 3 (e.g., food) is put between the upper electrode 2a and lower electrode 2b. The upper electrode 2a is movable upwardly and downward by a hoisting-and-lowering mechanism not shown, and its height is thus adjusted to a position according to the thickness of the to-be thawed object 3.

The high-frequency power source 4 outputs a voltage signal whose frequency band ranges from HF to VHF. The voltage signal from the high-frequency power source 4 is amplified to a desired power level by an amplifier (not shown). The amplified voltage signal is transmitted to the matching circuit 6 via the power detecting circuit 5.

The power detecting circuit 5 detects incident power (i.e., incident wave) that is incident on the matching circuit 6 from the high-frequency power source 4, and also detects reflective power (i.e., reflective wave) that reflects on the high-frequency power source 4 from the matching circuit 6. These detected signals are transmitted to the controller 7. The power detecting circuit 5 corresponds to a reflective-power detecting unit that detects the reflective power of the high-frequency voltage applied by the voltage applying unit.

As shown in FIG. 2, the matching circuit 6 includes variable capacitors 6a and 6b, a variable coil 6c, and other components. The matching circuit 6 cancels out the reactance of a capacitor formed by the upper electrode 2a and lower electrode 2b. The matching circuit 6 can also bring an impedance that is input to the matching circuit 6 into conformity with an impedance that is output to the amplifier, by regulating the values of the variable capacitors 6a and 6 and of the variable coil 6c. This enables the high-frequency thawing apparatus to efficiently apply a high-frequency electric field to the to-be thawed object 3. An output of the matching circuit 6 is supplied to the upper electrode 2a and lower electrode 2b in the heating chamber 1, thus heating, through high-frequency dielectric heating, the to-be thawed object 3 interposed between the upper electrode 2a and lower electrode 2b.

Referring back to FIG. 1, the controller 7 controls each unit of the high-frequency thawing apparatus, including the high-frequency power source 4 and matching circuit 6. Upon receiving, from the operation-input unit 8, an instruction to start thawing, the controller 7 adjusts the height of the upper electrode 2a using the hoisting-and-lowering mechanism not shown, and then operates the high-frequency power source 4.

The controller 7 receives the detected signals of the incident power and reflective power from the power detecting circuit 5. The controller 7 controls the output of the high-frequency power source 4 in such a manner that power obtained by subtracting the reflective power from the incident power, i.e., power that is effectively transmitted to components subsequent to the matching circuit 6, is constant.

FIG. 3 is a graph showing the relationship between thawing progress status and the detected signals of the incident power and reflective power that are detected by the power detecting circuit 5 while the to-be thawed object 3 is being thawed. The lateral axis of FIG. 3 denotes time (expressed in minutes): and the vertical axis thereof, power (expressed in watts; symbol W).

As shown in FIG. 3, the controller 7 controls the output of the high-frequency power source 4 in such a manner that the power obtained by subtracting the reflective power from the incident power is constant, to increase the incident power along with an increase in the reflective power. In the example of FIG. 3, the output of the high-frequency power source 4 is regulated in such a manner that the power obtained by subtracting the reflective power from the incident power always keeps at 150 W.

The reflective power steeply increases when the moisture in the to-be thawed object 3 starts to transform from a solid into a liquid upon application of a high-frequency electric field. Increasing the incident power continuously along with such an increase in the reflective power makes the output of the high-frequency power source 4 larger, thus rendering the high-frequency power source 4 and other components under heavy load. Accordingly, the controller 7 regulates the variable capacitors 6a and 6b, variable coil 6c, and other components in the matching circuit 6 to render the reflective power 0 W, when a ratio RW/FW exceeds a threshold X. The ratio RW/FW is the ratio of the reflective power (RW) to the incident power (FW). Such impedance regulation is repeated every time the ratio RW/FW exceeds the threshold X. In the example of FIG. 3, the threshold X is set to 10%; thus, impedance regulation is performed every time the ratio RW/FW exceeds 10%.

As shown in FIG. 3, for a while after the thawing starts, the amount of increase in the reflective power with respect to time is large, and the rate of change is steep. Such a period is referred to as an increase zone. This is because the moisture in the to-be thawed object 3 transforms much from a solid to a liquid during this period. After that, as time goes by, the amount of increase in the reflective power with respect to time becomes small, and the rate of change becomes gentle and goes nearly level in the end, followed by entering a stable zone indicating no steep increase. This is because as the thawing progresses, much of the moisture in the to-be thawed object 3 is turned into a liquid, thus decreasing changes in the moisture state. That is, the controller 7 can determine that the thawing has been completed, in response to the fact that the rate of change in the reflective power with respect to time has shifted from the increase zone, indicating a steep increase, to the stable zone, indicating no steep increase.

Using this relationship between the reflective power and the state change in the moisture of the to-be thawed object 3, the controller 7 determines thawing completion, by estimating the thawing progress status of the to-be thawed object 3 on the basis of how the detected signal of the reflective power has changed since the thawing was started. To be more specific, the controller 7 determines that the thawing has been completed, upon change in the detected signal of the reflective power from the increase zone, indicating steep increase, to the stable zone, indicating no steep increase.

In this preferred embodiment, the controller 7 determines that the to-be thawed object 3 has been thawed and thus stops the output of the high-frequency power source 4, when the ratio RW/FW does not exceed the threshold X even after a lapse of a predetermined time T1 since the impedance regulation performed to render the reflective power 0 W using the function of impedance regulation. The time T1 is set to a time such that the controller 7 can determine that the rate of change in the reflective power falls within the stable zone.

In the example of FIG. 3, the interval of the impedance regulation between the fourth and fifth times is about 2.2 minutes, which is longer than the previous intervals of about 1.5 minutes. Further, the interval of the impedance regulation between the fifth and sixth times is 5.3 minutes, which is further longer. The time T1 is set to 4 minutes, for instance, in such a waveform state. The controller 7 determines that the thawing has been completed and thus stops the output of the high-frequency power source 4, when the ratio RW/FW does not exceed 10% even after a lapse of 4 minutes since the impedance regulation.

The time T1 is a value that varies depending on the output of the high-frequency power source 4 or on the threshold X in the impedance regulation. Accordingly, with the thawing state of the to-be thawed object 3 being checked, the time T1 is set to a time at which the to-be thawed object 3 has been thawed uniformly at 0° C. For an apparatus that can change the output of the high-frequency power source 4 or change the threshold X in the impedance regulation, a plurality of times T1 are preferably retained based on combinations of variable parameters (or elements) that affect the time T1.

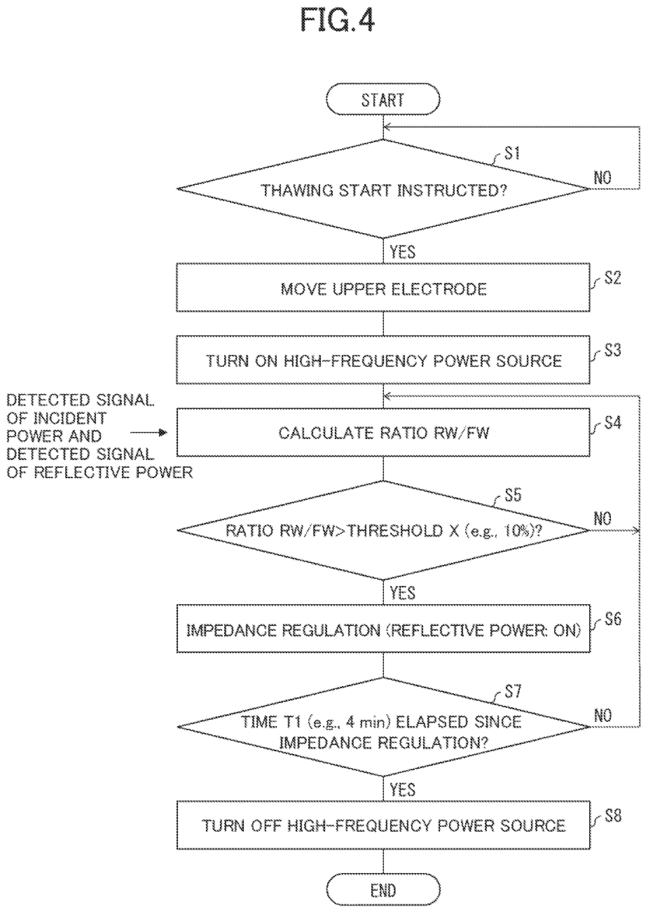

With reference to a flowchart in FIG. 4, the following describes the operation of the high-frequency thawing apparatus in the foregoing configuration. FIG. 4 is a flowchart showing the operation of the high-frequency thawing apparatus. A user puts the to-be thawed object 3 between the upper electrode 2a and lower electrode 2b, and inputs, via the operation-input unit 8, a signal instructing thawing. Upon receiving the signal from the operation-input unit 8 (i.e., if YES in S1), the controller 7 moves the upper electrode 2a to adjust the height of the upper electrode 2a. This process step is S2. Subsequently in S3, the controller 7 operates the high-frequency power source 4. Accordingly, a high-frequency voltage is applied between the upper electrode 2a and lower electrode 2b.

The high-frequency voltage supplied from the high-frequency power source 4 is supplied to the capacitor formed by the upper electrode 2a and lower electrode 2b, as a voltage signal that has undergone impedance matching in the matching circuit 6. Accordingly, a high-frequency electric field occurs between the upper electrode 2a and lower electrode 2b. The to-be thawed object 3 between the upper electrode 2a and lower electrode 2b is then heated through dielectric heating and is thus thawed.

While the high-frequency power source 4 is operating, the power detecting circuit 5 measures the incident power and reflective power, and send these power levels to the controller 7. In S4, using the received incident power and reflective power, the controller 7 calculates the ratio RW/FW. In S5, the controller 7 determines whether the calculated ratio RW/FW exceeds 10%, which is the threshold X.

If determining in S5 that the calculated ratio RW/FW does not exceed 10% (i.e., if NO), the controller 7 returns the process to S4 and re-calculates the ratio RW/FW. The controller 7 repeats the process steps in S4 and S5 until determining YES in S5. If determining in S5 that the calculated ratio RW/FW exceeds 10% (i.e., if YES), the controller 7 causes the matching circuit 6 to perform impedance regulation to render the reflective power 0 W. This process step is S6.

Upon performance of the impedance regulation, the controller 7 determines whether the time T1, e.g., 4 minutes, has elapsed since the regulation was performed. This process step is S7. If determining in S7 that the time T1 has not elapsed (i.e., if NO), the controller 7 returns the process to S4 and re-calculates the ratio RW/FW. The controller 7 repeats the process steps in S4 to S7 until determining YES in S7.

If determining in S7 that the time T1 has elapsed (i.e., if YES), the controller 7 stops the output of the high-frequency power source 4. This process step is S8. Since the ratio RW/FW does not exceed 10% even after a lapse of the time T1 since the impedance regulation performed to render the reflective power 0 W, the controller 7 can determine that the reflective power falls within the stable zone, meaning that the reflective power is stable, and can thus determine that the thawing has been completed. Consequently, the to-be thawed object 3 can be thawed uniformly with favorable precision in its finishing.

Although not shown in the flowchart of FIG. 4, the process proceeds to S8, i.e., stopping of the high-frequency power source, when the repetition of the process steps in S4 and S5 continues for over a predetermined time period.

Effects

In the foregoing configuration, the controller 7 estimates the thawing progress status of a to-be thawed object on the basis of how the detected signal of the reflective power has changed since the thawing was started. The controller 7 determines thawing completion upon change in the detected signal from the increase zone, indicating a steep increase (i.e., increase zone in which the rate of change in the reflective power with respect to time is steep), to the stable zone, indicating no steep increase (i.e., stable zone in which the rate of change in the reflective power with respect to time is gentle and nearly level).

Consequently, the high-frequency thawing apparatus determines thawing completion appropriately, without user setting of a thawing time based on the type and quantity (i.e., size) of the to-be thawed object 3. Accordingly, only putting the to-be thawed object 3, followed by instructing thawing start enables automatic thawing with favorable precision in finishing.

Determining thawing completion by measuring the surface temperature of the to-be thawed object 3 with an infrared sensor or other means, which less involves temperature non-uniformity than thawing with a micro wave, can cause excessive thawing or insufficient thawing if the temperature of the measured part is different from the temperature of most of the remaining parts. The forgoing configuration has no such problem, because thawing completion is determined using information obtained from the entire to-be thawed object 3 such as the detected signal of the reflective power.

In the foregoing configuration, the ratio RW/FW for use in impedance regulation is used to determine that the detected signal of the reflective power has changed to the stable zone, when the ratio RW/FW does not exceed the threshold X even after a lapse of the time T1 since previous impedance regulation. This enables the process step of determining thawing completion to be included in a conventional process for impedance regulation.

### Second Preferred Embodiment

A second preferred embodiment of the present invention will be described. For the sake of convenience in description, components whose functions are the same as those described in the foregoing preferred embodiment are denoted by the same signs and will not be elaborated upon.

For a food that is eaten without heated after thawed, such as “sashimi”, a Japanese dish of raw seafood, thawing preferably ends with the food heated to 10° C. for instance, rather than to 0° C. This is because a human tongue can sense food flavor and food taste better at 10° C. than at 0° C. Warming “sashimi” to over 0° C. within a range in which a human finds it cold enables the human to find “sashimi” more delicious.

Accordingly, the second preferred embodiment provides a high-frequency thawing apparatus that has a heating-extension node for heating the to-be thawed object 3 further even after change in the detected signal to the stable zone. Only in this regard, this high-frequency thawing apparatus is different from the high-frequency thawing apparatus according to the first preferred embodiment. Using the heating-extension mode enables the to-be thawed object 3 to be provided that is heated to a temperature higher than 0° C.

The controller 7 uses a required thawing time that is a time from heating start to when the detected signal reaches the stable zone, as an element for determining a heating-extension time for further heating. In other words, the controller 7 determines the heating-extension time in the heating-extension mode using at least the required thawing time.

In this preferred embodiment, upon selection of the heating-extension mode, the controller 7 continues to drive the high-frequency power source 4 during a set heating-extension time starting from a point in time when the controller 7 determines that the to-be thawed object 3 has been thawed. The heating-extension time is a time for heating, from 0° C. to 10° C. for instance, the to-be thawed object 3 whose temperature is 0° C. The heating-extension time thus needs to be set according to the thermal capacity of the to-be thawed object 3. The controller 7 uses a required thawing time Tt that is a time from when the thawing of the to-be thawed object 3 starts to when the thawing is determined to have been completed, as an element for determining the heating-extension time. This is because information about the thermal capacity of the to-be thawed object 3 is included in the required thawing time Tt. Using the required thawing time Tt, which varies according to the thermal capacity of the to-be thawed object 3, enables the heating-extension time to be set according to the thermal capacity of the to-be thawed object 3 without recognizing the type and quantity of the to-be thawed object 3.

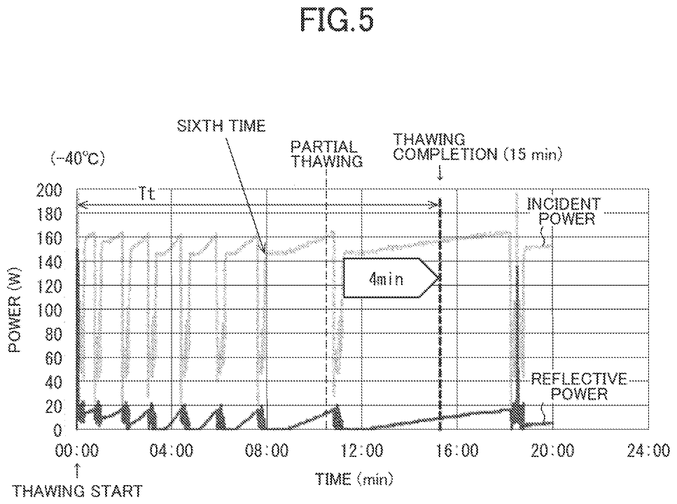

The required thawing time Tt, however, depends on the initial temperature of the to-be thawed object 3 other than the thermal capacity of the to-be thawed object 3. It is accordingly preferable to measure the initial temperature to correct the heating-extension time, obtained from the required thawing time Tt. The following describes this regard with reference to FIGS. 3 and 5.

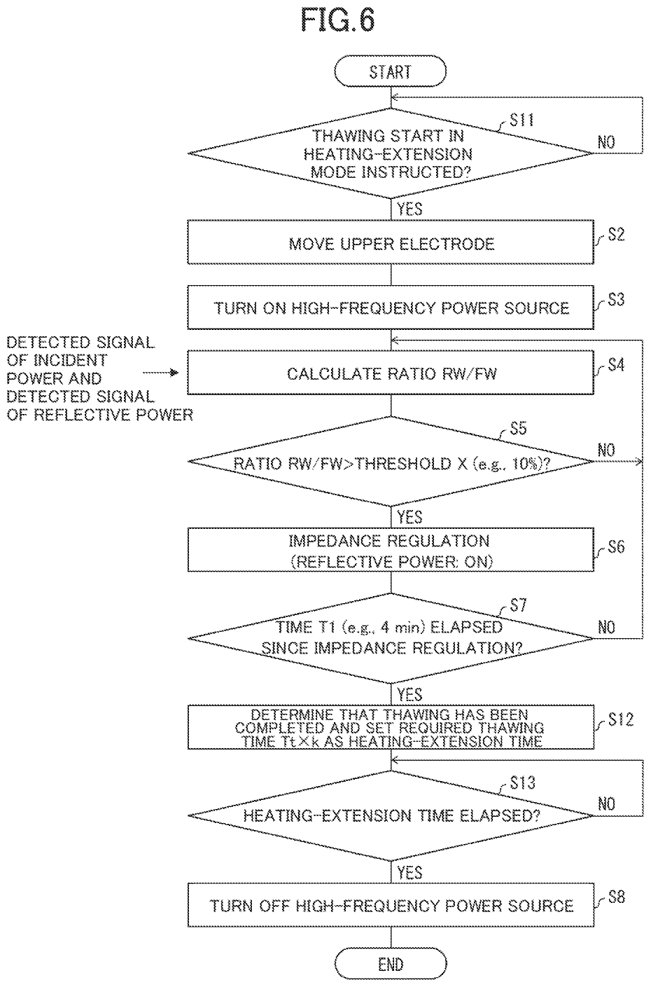

FIG. 5 is a graph showing the relationship between thawing progress status, and the detected signals of the incident power and reflective power that are detected by the power detecting circuit 5 while the to-be thawed object 3 is being thawed. As is the case with FIG. 3, the lateral axis of FIG. 6 denotes time (expressed in minutes); and the vertical axis of the same, power (expressed in watts; symbol W). FIGS. 3 and 5, although both handle the to-be thawed object 3, are different from each other in the initial temperature of the to-be thawed object 3; the initial temperature in FIG. 3 is −20° C., whereas the same in FIG. 5 is −40° C.

The comparison between FIGS. 3 and 5 reveals that the required thawing time Tt depends on the initial temperature, and that the required thawing time Tt is longer when the initial temperature is lower. For instance, let the heating-extension time be k times (where k is greater than zero) as long as the required thawing time Tt. Accordingly, the to-be thawed object 3 whose initial temperature is lower than the other, although heated from 0° C. similarly to the other, has a longer heating-extension time and thus has a higher finishing temperature.

For this reason, when the value k is set with reference to an initial temperature of −20° C. for instance, for the initial temperature being −40° C., the value k is corrected to satisfy the following equation: the required thawing time Tt (in the case of −40° C.)×k′ after correction=the required thawing time Tt (in the case of −20° C.)×k. The finishing temperature of the to-be thawed object 3 is accordingly stable regardless of the initial temperature.

A value for use in the correction of the value k is stored, as a table, in a storage included in the controller 7. The value k and the table for use in the correction of the value k are prepared for each set temperature in the heating-extension mode, when there are multiple set temperatures such as 10° C., 20° C. and 30° C.

With reference to a flowchart in FIG. 6, the following describes the operation of the high-frequency thawing apparatus. FIG. 6 is a flowchart showing the operation of the high-frequency thawing apparatus according to the present preferred embodiment. A user puts the to-be thawed object 3 between the upper electrode 2a and lower electrode 2b, and inputs, via the operation-input unit 8, a signal instructing thawing in the heating-extension mode. Upon receiving the signal from the operation-input unit 8 (i.e., if YES in S11), the controller 7 executes the process steps in S2 to S7, described in the flowchart of FIG. 4. Upon determining in S7 that the time T1 has elapsed (i.e., if YES), the controller 7 then executes S12 and S13 before S8, i.e., a process step of stopping the output of the high-frequency power source 4.

In S12, upon determining that the thawing has been completed, the controller 7 sets a required thawing time Tt×k (or k′) as a heating-extension time. In S13, the controller 7 then repeatedly determines whether the heating-extension time set in S12 has elapsed. Upon determining a lapse of the heating-extension time (i.e., if YES) in S13, the controller 7 proceeds to S8 to stop the output of the high-frequency power source 4.

In some preferred embodiments, the heating chamber 1 may be provided with an infrared thermometer for measuring the surface temperature of the to-be thawed object 3. Information about the initial temperature of the to-be thawed object 3 may be obtained from this infrared thermometer or from user input via the operation-input unit 8. The user can acquire the information about the initial temperature from a temperature that has been set for a freezer.

Using the operation-input unit 8, the user can select between normal thawing, in which thawing stops at 0° C., and thawing in the heating-extension mode. The operation-input unit 8 may be provided with a thawing button for starting normal thawing, and with a heating-extension thawing button for starting thawing in the heating-extension mode. Alternatively, the operation-input unit 8 may be provided with a thawing start button for starting normal thawing, and with a selection button for the user to operate before the thawing start button to thus select thawing in the heating-extension mode. A temperature to be reached under thawing in the heating-extension mode may be selected from among predetermined temperatures, such as 10° C. and 20° C., or may be set to any temperature ranging from 5 to 30° C. for instance.

### Third Preferred Embodiment

A third preferred embodiment of the present invention will be described. For the sake of convenience in description, components whose functions are the same as those described in the foregoing preferred embodiments are denoted by the same signs and will not be elaborated upon.

For slicing food materials, some (e.g., meat) of them are easier to process when they are frozen in their entirety enough to be easily cut with a kitchen knife or slicer, than when they have thawed completely. Accordingly, a desired function is to stop thawing when such a food material has thawed partially, a state where the entire food material is frozen enough to be easily cut with a kitchen knife or slicer. The third preferred embodiment provides a high-frequency thawing apparatus that additionally has a partial-thawing function in which the high-frequency thawing apparatus stops thawing with the to-be thawed object 3 thawed partially. Only in this regard, this high-frequency thawing apparatus is different from the high-frequency thawing apparatus according to the first preferred embodiment.

Upon selection of partial thawing, the controller 7 changes the time T1, described in the flowchart of FIG. 4, to a time T2 that is shorter than the time T1 and appropriate for partial thawing. The controller 7 thus determines that the to-be thawed object 3 has been thawed partially, when the ratio RW/FW does not exceed 10% even after a lapse of the time T2 since impedance regulation performed to render the reflective power 0 W. The controller 7 then stops the high-frequency power source 4.

The time T2 for determining that the to-be thawed object 3 has thawed partially is preferably regulated according to the initial temperature of the to-be thawed object 3. As shown in FIG. 5, the time T2 is set to 3 minutes when the initial temperature is −40° C. Thus, since the ratio RW/FW does not exceed 10% even after a lapse of 3 minutes since the sixth time impedance regulation, the controller 7 determines, at this point in time, that the to-be thawed object 3 has thawed partially. As shown in FIG. 3, the time T2 is set to 2 minutes when the initial temperature is −20° C. Thus, since the ratio RW/FW does not exceed 10% even after a lapse of 2 minutes since the fourth time impedance regulation, the controller 7 determines, at this point in time, that the to-be thawed object 3 has thawed partially.

Using the operation-input unit 8, a user can select between complete thawing and partial thawing. The operation-input unit 8 may be provided with a complete-thawing button for starting complete thawing, and with a partial-thawing button for starting partial thawing. Alternatively, the operation-input unit 8 may be provided with a thawing start button for starting complete thawing, and with a selection button for the user to operate before the thawing start button to thus select partial thawing.

### SUMMARY

A high-frequency thawing apparatus according to a first aspect of the present invention includes the following: the heating chamber 1; the upper electrode 2a and lower electrode 2b with the to-be thawed object 3 interposed therebetween, the upper electrode 2a and lower electrode 2b being disposed in parallel to each other in the heating chamber 1; a voltage applying unit (i.e., high-frequency power source 4 and matching circuit 6) that applies a high-frequency voltage between the upper electrode 2a and lower electrode 2b; a reflective-power detecting unit (i.e., power detecting circuit 5) that detects the reflective power of the high-frequency voltage applied by the voltage applying unit; a thawing-completion determining unit (i.e., controller 7) that determines thawing completion, by estimating the progress status of the to-be thawed object 3 on the basis of how a detected signal detected by the reflective-power detecting unit has changed since thawing was started; and a control unit (i.e., controller 7) that controls the voltage applying unit on the basis of a determination made by the thawing-completion determining unit.

A high-frequency thawing apparatus according to a second aspect of the present invention may be configured, in the first aspect, that upon change in the detected signal from an increase zone to a stable zone, the thawing-completion determining unit determines that the thawing has been completed. The increase zone indicates a steep increase in the reflective power. The stable zone indicates no steep increase in the reflective power.

A high-frequency thawing apparatus according to a third aspect of the present invention can be configured, in the second aspect, to have a heating-extension mode for further heating even after the change in the detected signal to the stable zone. The high-frequency thawing apparatus can also be configured such that the control unit uses a time ranging from heating start to when the detected signal reaches the stable zone, as an element for determining a time for the further heating in the heating-extension mode.

A high-frequency thawing apparatus according to a fourth aspect of the present invention can also be configured, in the third aspect, such that the control unit further uses information about the temperature of the to-be thawed object 3 measured before the heating start, as an element for determining the time for the further heating in the heating-extension mode.

A high-frequency thawing apparatus according to a fifth aspect of the present invention, can also be configured, in any of the first to fourth aspects, such that the voltage applying unit includes the matching circuit 6 that performs impedance regulation when the ratio of the reflective power to the high-frequency voltage exceeds a threshold. The high-frequency thawing apparatus can also be configured such that when the ratio of the reflective power to the high-frequency voltage does not exceed the threshold even after a lapse of a predetermined time since the impedance regulation performed by the matching circuit 6, the thawing-completion determining unit determines that the thawing has been completed.

The present invention is not limited to each of the foregoing preferred embodiments. Numerous modifications can be made within the scope of the claims. The technical scope of the present invention encompasses a preferred embodiment as well that is obtained in combination, as necessary, with the technical means disclosed in the respective different preferred embodiments. Furthermore, combining the technical means disclosed in the respective preferred embodiments can form a new technical feature.

What is claimed is:

1. A high-frequency thawing apparatus comprising:
a heating chamber;
upper and lower electrodes with a to-be thawed object interposed therebetween, the upper and lower electrodes being disposed in parallel to each other in the heating chamber;
a voltage applying unit configured to apply a high-frequency voltage between the upper and lower electrodes;
a reflective-power detecting unit configured to detect a reflective power of the high-frequency voltage applied by the voltage applying unit;
a thawing-completion determining unit configured to determine thawing completion, by estimating a progress status of the to-be thawed object on the basis of how a detected signal detected by the reflective-power detecting unit has changed since thawing was started; and
a control unit configured to control the voltage applying unit on the basis of a determination made by the thawing-completion determining unit.

2. The high-frequency thawing apparatus according to claim 1, wherein upon change in the detected signal from an increase zone to a stable zone, the thawing-completion determining unit determines that the thawing has been completed, the increase zone indicating a steep increase in the reflective power, the stable zone indicating no steep increase in the reflective power.

3. The high-frequency thawing apparatus according to claim 2, wherein
the high-frequency thawing apparatus has a heating-extension mode for further heating even after the change in the detected signal to the stable zone, and
the control unit uses a time ranging from heating start to when the detected signal reaches the stable zone, as an element for determining a time for the further heating in the heating-extension mode.

4. The high-frequency thawing apparatus according to claim 3, wherein the control unit further uses information about a temperature of the to-be thawed object measured before the heating start, as an element for determining the time for the further heating in the heating-extension mode.

5. The high-frequency thawing apparatus according to claim 1, comprising
a matching circuit configured to perform impedance regulation when a ratio of the reflective power to an incident power of the high-frequency voltage exceeds a threshold,
wherein when the ratio of the reflective power to the incident power of the high-frequency voltage does not exceed the threshold even after a lapse of a predetermined time since the impedance regulation performed by the matching circuit, the thawing-completion determining unit determines that the thawing has been completed.
